(19) United States
(12) Patent Application Publication
(10) Pub. No.: US 2015/0130848 A1
(43) Pub. Date: May 14, 2015

(54) INFORMATION PROCESSING DEVICE, INFORMATION PROCESSING METHOD, AND PROGRAM

(71) Applicant: Hitachi Maxell, Ltd., Osaka (JP)

(72) Inventors: Hidenori Sakaniwa, Tokyo (JP); Masahiro Ogino, Tokyo (JP); Nobuhiro Fukuda, Tokyo (JP); Kenta Takanohashi, Tokyo (JP)

(73) Assignee: Hitachi Maxell, Ltd., Osaka (JP)

(21) Appl. No.: 14/404,546

(22) PCT Filed: Mar. 6, 2013
(86) PCT No.: PCT/JP2013/056065

§ 371 Date: Nov. 28, 2014

(30) Foreign Application Priority Data
May 30, 2012 (JP) 2012-122640

(51) Int. Cl. G06T 3/40; G06T 7/00; G06K 9/00

(52) U.S. Cl. CPC G06T 3/40; G06K 9/00637; G06T 7/0051
USPC 345/666

(57) ABSTRACT

A technique to output map information to appropriately match imaged images is to be provided. An information processing device includes an input unit that inputs image information acquired by imaging; an output unit that outputs map information; and a control unit that controls the input unit and the output unit, wherein the control unit performs control, according to depth distance information acquired from the image information, to vary the downscale ratio of the map information outputted from the output unit.

### TECHNICAL FIELD

The present invention relates to an information processing device, an information processing method, and a program.

### BACKGROUND

A case of background art in this technical field is disclosed in Japanese Unexamined Patent Application No. 2006-33274. The gazette of this patent application states: “The configuration includes an image acquiring unit that acquires imaged images and imaging position information associated with the pertinent imaged images; a printing unit that prints map images, together with imaged images, on a prescribed print medium; a downscale ratio determining unit that determines the downscale ratio of maps on the basis of the imaging position information; and a control unit that causes the printing unit to print map images of the determined downscale ratio together with the imaged images. For instance, the downscale ratio is determined on the basis of the distance from the imaging position to a prescribed reference position, whether the imaging position is inside or outside a specific country, or the differences in imaging position among a plurality of acquired imaged images. The downscale ratio may as well be determined on the basis of the distance of the imaging object at the time of imaging the imaged image.”

### SUMMARY

Although the art disclosed in Japanese Unexamined Patent Application No. 2006-33274 enables the downscale ratio of map images to be determined on the basis of imaging position information, no consideration is given to information on the depths of imaged images.

In view of this problem, the present invention is intended to provide a technique to appropriately output map information according to individual imaged images.

In order to solve the problem noted above, a configuration stated in one or another of the Claims is used.

Whereas the present invention covers a plurality of means to address the problem, according to one of them, there is provided an information processing device including an input unit that inputs image information acquired by imaging; an output unit that outputs map information; and a control unit that controls the input unit and the output unit, wherein the control unit performs control, according to depth distance information acquired from the image information, to vary the downscale ratio of the map information outputted from the output unit.

The invention has the advantageous effect of outputting map information appropriately according to what imaged images require.

### BRIEF DESCRIPTION OF THE DRAWINGS

Other problems, configurations and advantageous effects than those described above will be made clear by the following description of embodiments of the present invention when taken in conjunction with the accompanying drawings, wherein:

FIG. 1 shows an example of system configuration of a first embodiment of the present invention;

FIG. 2 is a block diagram of a typical configuration of terminals in the first embodiment of the present invention;

FIG. 3 is a flow chart showing one example of map information-linked imaging processing in the first embodiment of the present invention;

FIG. 4 illustrates a model to calculate distances from information on the parallax between right and left images imaged with a parallel stereo camera;

FIG. 5 shows a case where right and left images imaged with a parallel stereo camera are processed for stereo matching and differentiated into distance ranges on a gray scale;

FIG. 6 shows an example of depth rate histogram matching a imaged image of the first embodiment of the present invention;

FIG. 7 is a tabulated example of calculated depth rate and map downscale ratio in the first embodiment of the present invention;

FIGS. 8-1 and 8-2 show an example of service provided pertaining to the first embodiment of the present invention;

FIG. 9 is a block diagram of a typical configuration of a terminal in a second exemplary embodiment of the present invention;

FIGS. 10-1 and 10-2 show an example of service provided pertaining to the second embodiment of the present invention;

FIG. 11 is a flow chart showing one example of map information-linked imaging processing in a third exemplary embodiment of the present invention;

FIG. 12 is a block diagram of a typical configuration of a terminal in a fourth exemplary embodiment of the present invention; and

FIGS. 13-1 and 13-2 show an example of service provided when the present invention is applied to a vehicle-mounted case.

### DETAILED DESCRIPTION

Embodiments of the present invention will be described below with reference to the accompanying drawings. In the following embodiments, raising the downscale ratio is supposed to give a map of a greater area (a map more reduced in scale) and lowering the downscale ratio is supposed to give a map of a smaller area (a map less reduced in scale).

### First Embodiment

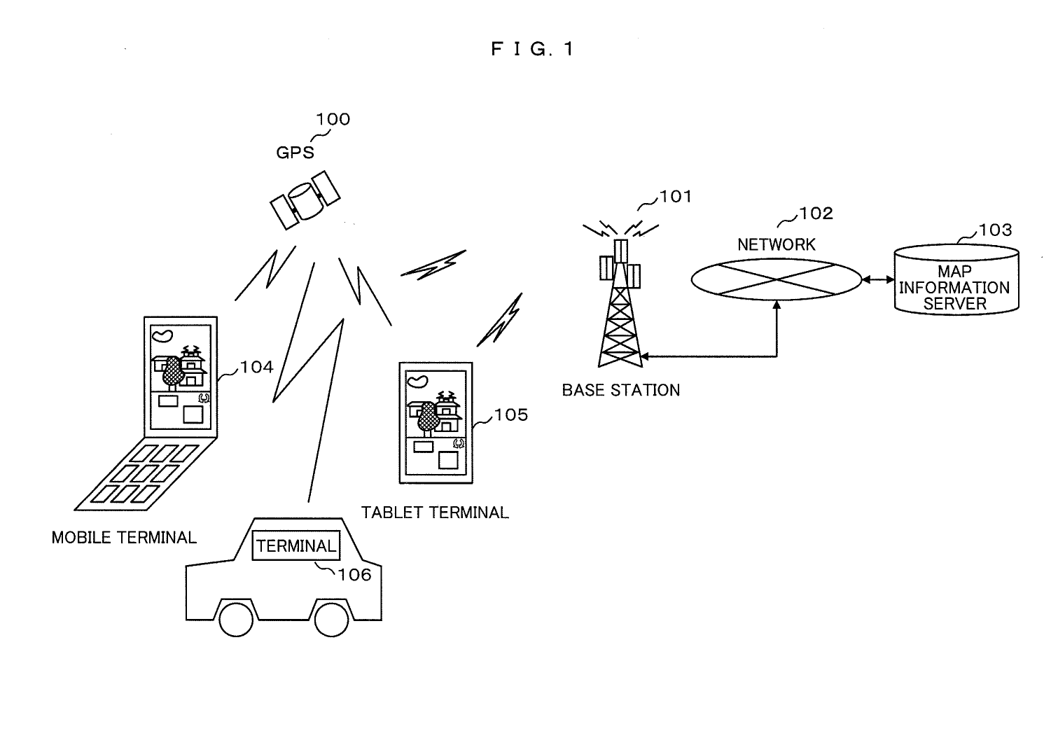

A first embodiment of the present invention will be described below with reference to FIGS. 1 through 8.

FIG. 1 shows an example of system configuration of this embodiment.

A mobile terminal 104, a tablet terminal 105 and a vehicle-mounted terminal 106 (car navigation device or the like) are mounted with a function or the like to infer depth distance information from a display unit, an imaging unit, a Global Position System (GPS) receiver, and imaged images, and computes the map downscale ratio on the basis of the depth distance information calculated from the imaged images. The vehicle-mounted terminal 106 may have its function either built into or fitted to a car (vehicle).

The mobile terminal 104, the tablet terminal 105 and the vehicle-mounted terminal 106 transmits by wireless communication the map downscale ratio information and the GPS positional information acquired by the GPS receiver mounted on the terminal to a map information server 103 connected to a network 102 via a base station 101, acquires map information (map images and vector information on maps) from the map information server 103, and displays a map at an appropriate downscale ratio.

The base station 101 can utilize not only access points of a mobile telephone communication network but also one or another of various wireless communication systems including wires LAN (IEEE 802.11 communication), wires USV, i02.16 standard and Bluetooth®. Further, it can use not only wireless but also wire communication.

The network 102 is an Internet Protocol (IP) network on which information can be communicated in various ways, such as the Internet.

The map information server 103 is connected to the network 102. The map information server 103, having the latest map information, can search map information on its surroundings from latitude and longitude information. It also has a mechanism to send map information, vector map information, character information and the like at a required downscale ratio.

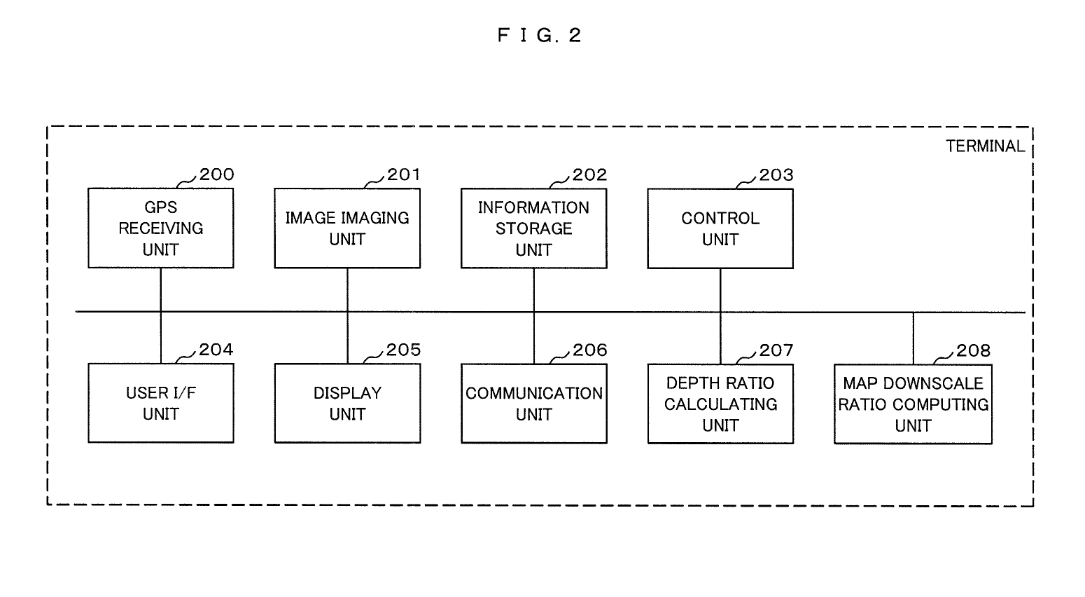

FIG. 2 is a block diagram of a typical configuration of the mobile terminal 104, the tablet terminal 105 and the vehicle-mounted terminal 106 in this embodiment.

The mobile terminal 104, the tablet terminal 105 and the vehicle-mounted terminal 106 are equipped with a GPS receiving unit 200, an image imaging unit 201, an information storage unit 202, a control unit 203, a user I/F unit 204, a display unit 205, a communication unit 206, a depth ratio calculating unit 207, and a map downscale ratio computing unit 208.

The GPS receiving unit 200 has a mechanism that can find the position of a terminal, which serves as the receiver, by measuring the distance from the lengths of time taken by radio waves to arrive from a plurality of GPS satellites. Position finding may as well use Assisted GPS (AGPS) utilizing a server installed in the network to support position finding. AGPS, equipped with a reference antenna connected to the supporting server, has a mechanism to enhance the accuracy of position finding by transmitting to a terminal all GPS satellite information and sensitivity enhancing support information that may be received by the terminal.

The image imaging unit 201, including one or more cameras, can generate information including still images and moving images by imaging (shooting, photographing), digitizes the information and output it to the information storage unit 202. Image information generated by an external imaging unit may as well be inputted.

The information storage unit 202 is configured of built-in memories (including HDD, SRAM, flash ROM, SDRAM and SSD) and external memories (including SD card and Compact Flash® memory). It may well be configured of combining such memories.

The control unit 203 regulates requests from and communicates with functional blocks and thereby controls the functions of this embodiment.

The user I/F unit 204 is an interface (IF) that accepts various requests from the user for accepts the user's requests for various actions including start of imaging, expansion or turning of map images received from the map information server 103, zooming of the camera and manipulation of an image (in the process of being imaged) seen on the image imaging unit 201 at the time or accessing a stored image.

The display unit 205 displays still images and moving images by using a liquid crystal display or an organic EL. It displays, for instance, an image currently imaged by the image imaging unit 201, a map image received from the map information server 103, an image synthesized from these images, or an image stored in the information storage unit 202.

The user I/F unit 204 and the display unit 205 may take an integrated form like a touch panel.

Incidentally in the following description of the embodiment, stored image information generated by imaging by the image imaging unit 201 and image information being currently imaged by the image imaging unit 201 are referred to as imaged images.

The communication unit 206 can use diverse wireless communication systems including 3GPP and 3GPP2 operated by a communication carrier, CDMA, TDMA, W-CDMA, 1xEV-DO, cdma2000 and GSM® conforming to the standards of GSMA wireless communication such as EDGE, wireless LAN (IEEE 802, 11-based communication), wireless USB, 802.16 standards and Bluetooth®. It may as well be configured of a plurality of wireless antennas when wireless communication increased in speed with Multiple Input Multiple Output (MIMO) is to be used. The communication unit 206 can perform not only wireless communication but also wire communication such as optical cable communication of ADSL.

The depth ratio calculating unit 207, receiving inputs of a plurality of stereo images acquired from the image imaging unit 201, performs processing of stereo matching among others to calculate depth distance information regarding imaged images. Calculation of depth ratio information may be performed with respect to either each pixel or each block of a certain range. It may also be performed with respect to each prescribed area. The stereo images may be acquired either with a plurality of cameras or with images from only one camera using a rule base. The configuration may include one or more distance sensors, or a combined distance sensor-camera image configuration may acquire depth distance information on the surroundings.

Then, the depth distance information is classified by distance range, and depth ratio information indicating pixels (or blocks or areas, which will all be represented by pixels in the following description) of what depth are present in what ratios is calculated. From the calculated depth ratio information, the map downscale ratio computing unit 208 infers whether the user is imaging a distance landscape or the like or in an urban place having many buildings nearby or the like. As the technique to classify the depth distance information by distance range, a histogram of each distance range may be utilized, or frequency analysis using FFT or the like, edge emphasizing technique, pattern matching system, eigenspace method, or a technique by which the object of each depth distance information item is recognized on the basis of the movement range and the square measure of the object may be utilized.

The map downscale ratio computing unit 208 infers, according to the depth ratio information calculated by the depth ratio calculating unit 207, whether the object imaged by the user is far away or nearby, and computes the downscale ratio needed by the user.

For instance, the smaller the number of deep pixels, blocks or other elements in the imaged image according to the depth ratio information, the nearer the object to the user's presumable position, and the downscale ratio of the map information is raised (the map size is reduced) (1:1,000 to 1:10,000 or the like) to acquire map information on a greater range (greater area).

Or, the smaller the number of deep pixels, blocks or other elements in the imaged image according to the depth ratio information, the nearer the object to the user's presumable position, and the downscale ratio of the map information is lowered (the map size is enlarged) (1:5,000 to 1:1,000 or the like) to acquire map information on a smaller range (smaller area).

If the number or ratio of deep pixels, blocks or the like in imaged images has surpassed its threshold, the downscale ratio of the map may be changed. This could prevent an excessive variation in downscale ratio resulting from variations in imaged images. Or in the increasing (decreasing) process of the number or ratio of deep pixels, blocks or the like, downscale ratio switching-over to raise (lower) the downscale ratio may be processed.

The GPS positional information acquired by the GPS receiving unit 200 and the map downscale ratio information computed by the map downscale ratio computing unit 208 are transmitted to the map information server via the communication unit 206.

Here, the depth ratio calculating unit 207 and the map downscale ratio computing unit 208 may as well be located in an arithmetic server outside the terminal. In this case, a decentralized processing system is used in which imaged images are transmitted by wireless communication to the arithmetic server, which calculates depth ratio information and downscale ratio information from the imaged images and transmits map information corresponding to the result of calculation to the terminal. Since the processing by the depth ratio calculating unit 207 and the map downscale ratio computing unit 208 can be transferred to the arithmetic server, the processing load on the terminal can be reduced, resulting in contribution to power saving at the terminal.

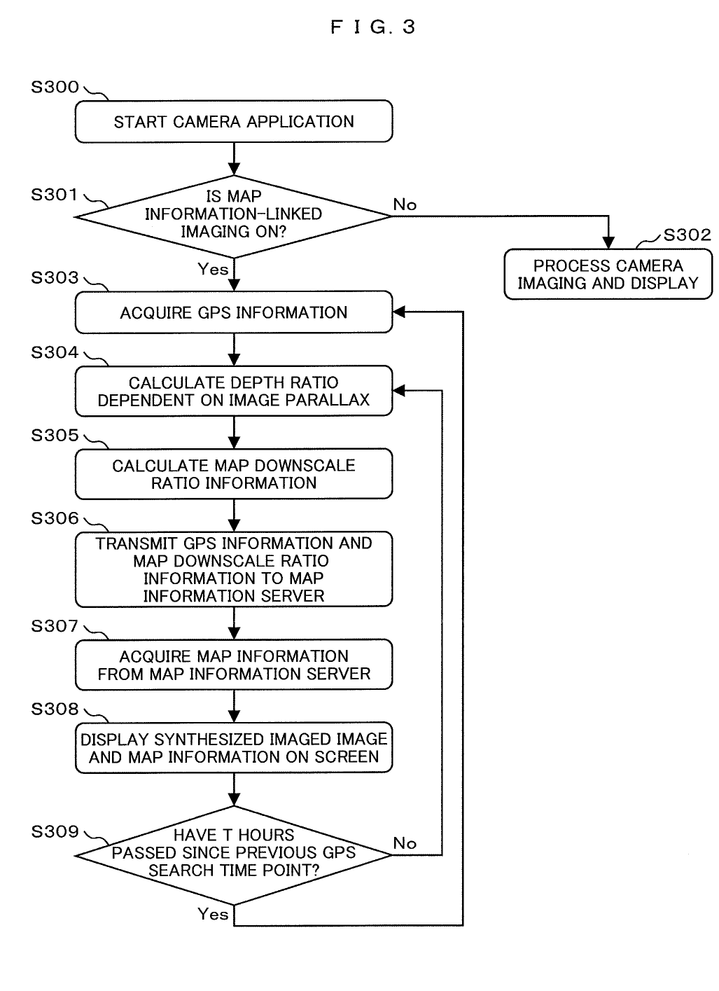

FIG. 3 is a flow chart showing one example of map information-linked imaging processing in this embodiment.

A camera start request or a choice as to whether or not to image images linked with map information is received from the user via the user I/F unit 204 (S300).

If the user does not choose imaging linked with map information (“No” at S301), the flow shifts to S302 to process camera imaging and displaying of imaged images or the like.

If the user has chosen imaging linked with map information (“Yes” at S301), GPS positional information is acquired (S303). 5303 may be, for instance, either immediately after S300 or before S305; it has only to be processed before sending GPS positional information and map downscale information to the map information server 103 at S306.

At S304, depth ratio information is calculated. When one camera is used to calculate the depth ratio information, that one camera is started or, when a plurality of cameras are used to calculate the depth ratio information, the plurality of cameras are started. When a plurality of cameras are used, the plurality of cameras may be started at the timing of calculating the depth ratio information. In this way, all the cameras but one can be kept in a sleeping state to achieve an effect to reduce power consumption by the cameras.

Then, on the basis of a stereo image acquired from the camera, parallax-based distance estimation (calculation of depth distance information) is processed. From the calculated depth distance information on each calculated pixel, the ratio of the number of pixels in each depth range contained in the imaged image is calculated (calculation of depth ratio information).

At S305, map downscale ratio information corresponding to the calculated depth ratio information is calculated, or map downscale ratio information is figured out by referencing tabulated values.

At S306, the acquired GPS positional information and map downscale ratio information are transmitted to the map information server 103 via the network.

At S307, the map information sent from the map information server on the basis of the transmitted GPS positional information and map downscale ratio information is acquired.

At S308, the imaged image and the map information acquired from the map information server are synthesized and displayed on the display unit 205. This results in displaying of the map information at a downscale ratio appropriate for imaged images on the display unit 205 together with the imaged images.

At S309, it is figured out whether or not T hours have has passed since the previous GPS search time point. If not, the GPS positional information is not updated, and the processing shifts to S304 for downscale ratio updating in the same position, with the depth ratio information based on the parallax from the stereo image being figured out from time to time. When the depth ratio information has varied at or beyond a threshold, the map downscale ratio is recalculated to obtain a map of an updated downscale ratio from the map information server. On the other hand, if T hours have has passed since the previous GPS search time point, the processing shifts to S303, and the GPS positional information is also updated.

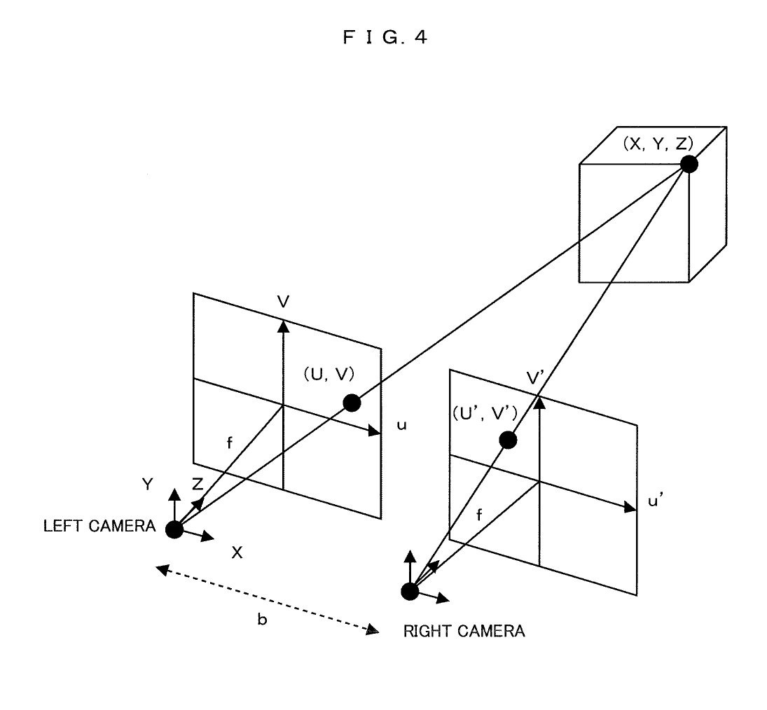

FIG. 4 illustrates a model to calculate distances from information on the parallax between right and left images imaged with a parallel stereo camera.

In the case shown in FIG. 4, there are two cameras, right and left, which are arranged in parallel and away from each other by a distance b. With the intersection point between the optical axis of the camera and the image surface being taken as the origin, and the coordinates on the left camera image being represented by (u, v), those on the right camera by (u′, v′) and the focal distance of the camera by f, a position (X, Y, Z) in the three-dimensional space is calculated by the following equations:

X=bu/u−u′

Y=bv/u−u′

Z=bf/u−u′

where u-u′ is the extent of horizontal deviation of the projection points in the two images, and is defined to be the parallax. Since the depth distance information Z in the space is determined by the parallax u-u′ if b and f are constant, the depth distance of a given pixel can be figured out by calculating the parallax u-u′ between a pair of corresponding points in two images.

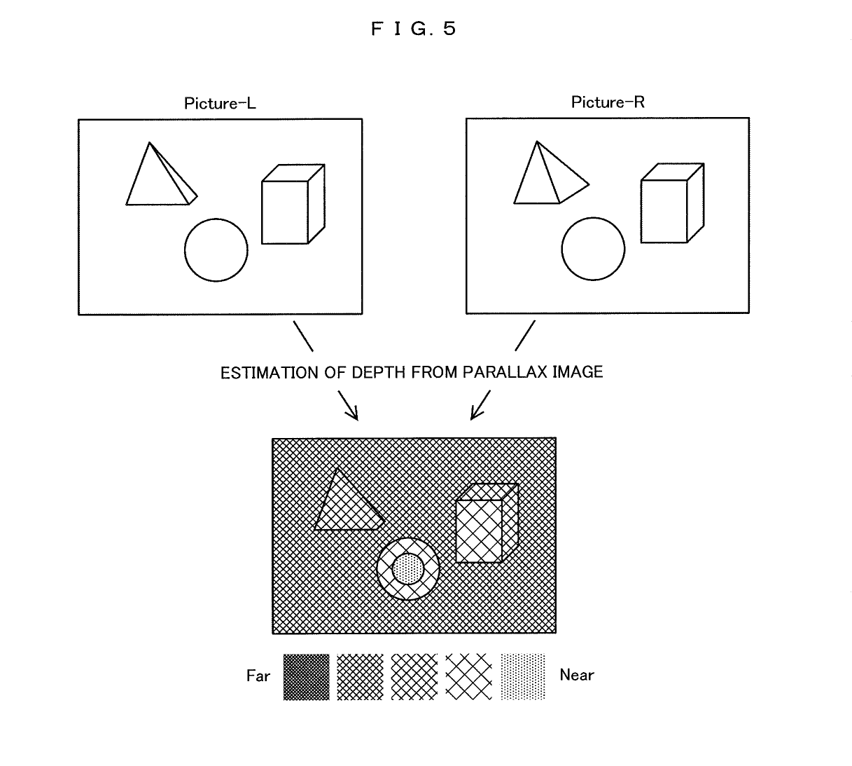

FIG. 5 shows a case where right and left images imaged with a parallel stereo camera are processed for stereo matching and differentiated into distance ranges on a gray scale.

To figure out the position of the three-dimensional space by using the inputted images, stereo correspondence and stereo matching to identify the position in which a given point in the space of each of the right and left images is processed. Usually, area-based matching utilizing template matching, feature-based matching by which feature points such as edges and corner points of each image are extracted and correspondence between the feature points is searched for, or multi-baseline stereo using a plurality of cameras is applied.

The parallax of each of the pixels or the like matched by one or another of these techniques is figured out, from which depth distance information of the pixel or the like can be calculated. FIG. 5 shows typical pictures in which tones are differentiated by depth distance range in a gray scale in which the smallest depth distance information (the area nearest to the camera) is represented by white and the greatest depth distance information (the area farthest from the camera), by black.

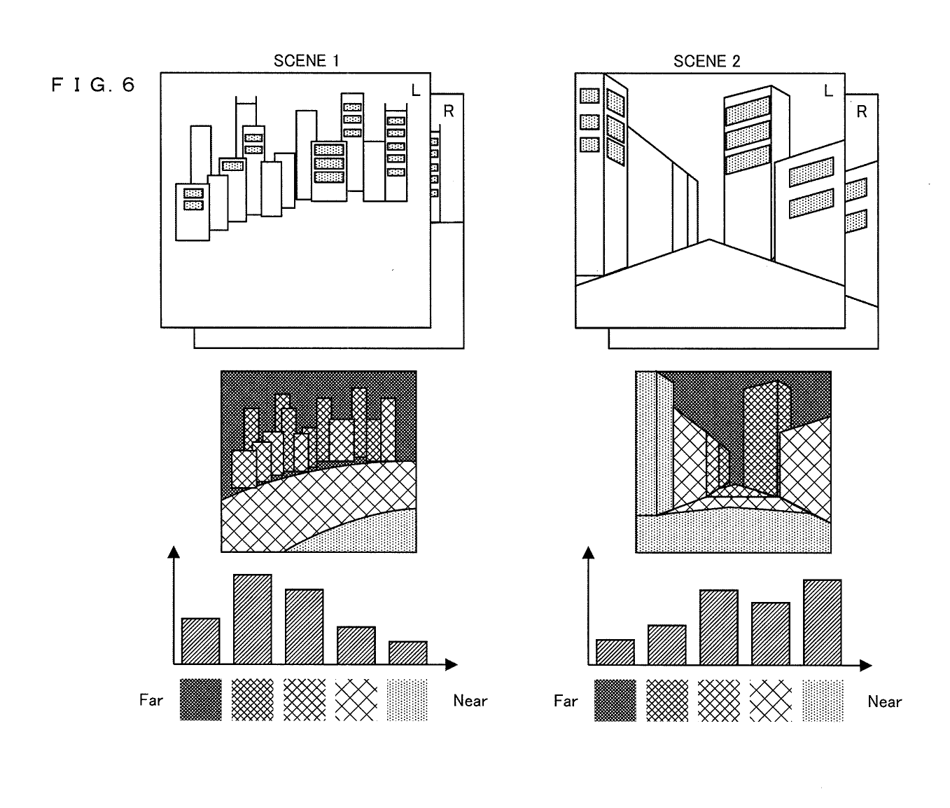

FIG. 6 shows an example of depth rate histogram matching a imaged image of this embodiment.

Scene 1 is an exemplary stereo image of imaging (or having imaged) a group of buildings far away, and Scene 2 is one of imaging (or having imaged) an urban location having buildings nearby. FIG. 6 shows examples of images in which depth distances are gray-scaled and histograms of the number of pixels in each depth distance range obtained by stereo-matching the two scenes.

Scene 1 has its pixel number peak toward the black, figured out to be the farthest in depth distance, while Scene 2 has a concentration of pixels toward the white, figured out to be the nearest in depth distance. By calculating the depth distance from stereo images of imaged scenes in this way, the scenes can be inferred.

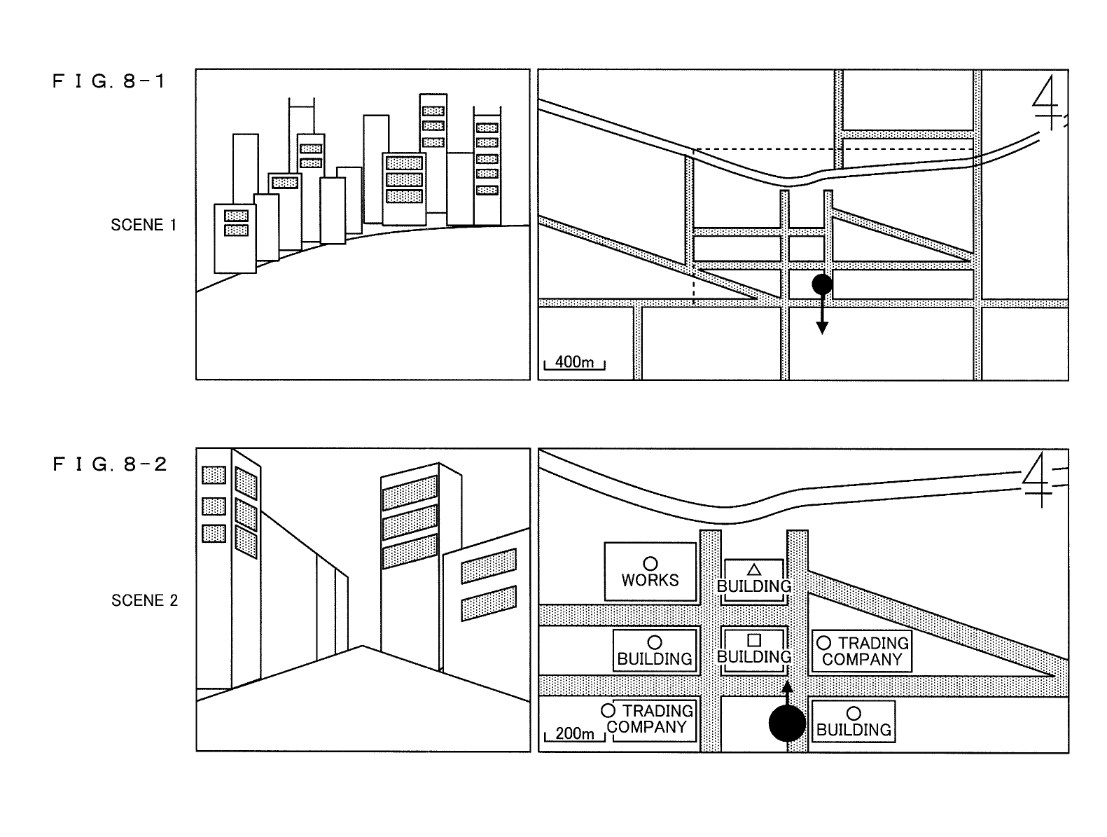

In the scene inference by the calculation of depth distance information, adaptive selection is made for a case like Scene 1 to display a map of a downscale ratio at which the one memory measure stated in the lower left part is 400 m for instance as shown in FIG. 8-1, or for one like Scene 2 to display a map of a downscale ratio at which the one memory measure is 200 m for instance as shown in FIG. 8-2. This enables the user to confirm the position on a map of a downscale ratio matching the imaged images.

Further, by using the technique described with respect to this embodiment, even where no imaged image, but only map information, is shown on the display unit, the downscale ratio of the map is enabled to be adaptively varied by changing the direction of the imaging unit (camera) of the terminal. This makes possible a reduction in terminal process as much as the dispensation with displaying of imaged images. There is another advantage of enabling the map to be displayed in a greater size by utilizing the whole display unit screen. Furthermore, by imaging the ground around the user's feet or closing the image by hand for instance, the depth distance is shortened and the downscale ratio of the map is lowered, making it possible to acquire information on the destination if it is nearby.

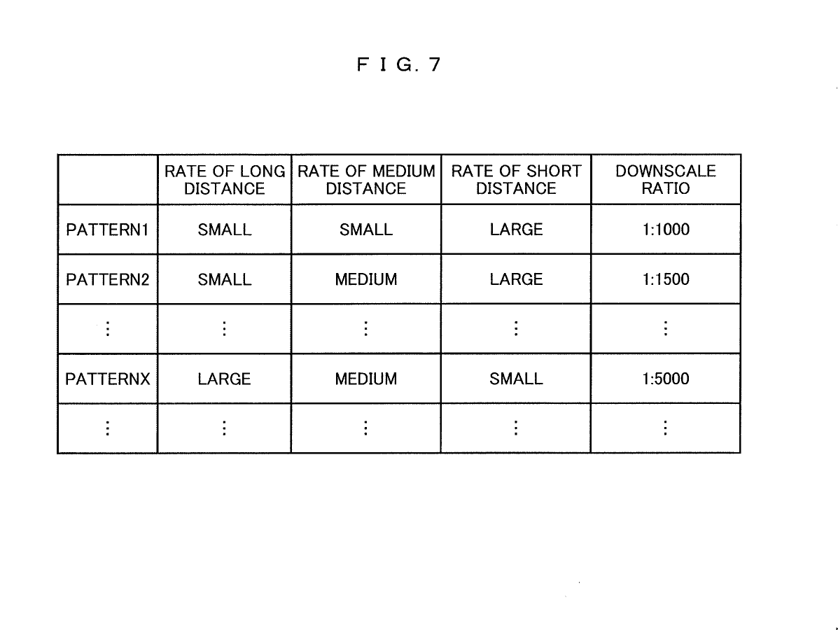

FIG. 7 is a tabulated example of calculated depth rate and map downscale ratio pertaining to this embodiment.

This is a table in which the map downscale ratio is set according to the proportion of pixels of greater depth distances to the whole image. In the case shown in FIG. 7, for instance pixels whose depth distances belong to a prescribed value range are supposed to be pixels with higher rates of long distance, and the rates of pixels in different depth distance ranges to the whole image are classified into “large”, “medium” and “small” according to such rates to the whole image and thresholds.

For instance, where pixels in a long distance range account for 10%, ones in a medium distance range, for 10% and ones in a short distance range, for 80%, in a map downscale pattern 1, the image can be inferred as imaging a nearby object, and therefore the map downscale ratio is lowered to display a map at such a downscale ratio as enables information in the nearby area to be known.

By providing such a table, the processing load can be made smaller than in the case of determining the downscale ratio by calculating every time one of many combinations of depth rates calls for determination. There is a further advantage that downscale ratio setting that matches the user's preference, which otherwise the user would have to do by utilizing the user I/F unit 204, can be done by choosing an appropriate pattern in FIG. 7.

Although FIG. 7 shows a rule expressed in a table of depth rates and map downscale ratios, the map downscale ratio may as well be figured out from the value of the gravity center or peak in the depth distance histogram.

The downscale ratio may also be determined by calculation when it is needed according to the combination of depth rates.

FIGS. 8-1 and 8-2 show an example of service provided pertaining to this embodiment.

Where a landscape in which buildings are seen in the distance is being imaged for example as in Scene 1 of FIG. 8-1, a map of a downscale ratio for large areas (the downscale ratio of one memory measure is 400 m in FIG. 8-1) is displayed. Where an urban place having many buildings nearby is being shown as in Scene 2 of FIG. 8-2, a detailed map of the surroundings of the urban place (the downscale ratio of one memory measure is 200 m in FIG. 8-2), which makes specifically understandable even what kinds of buildings stand in the area around, is displayed. In this way, a map of a downscale ratio appropriate for the depth distance of the imaged object is displayed to facilitate recognition of the relation between the imaged image and the map.

According to the embodiment so far described, since it enables a map of a downscale ratio appropriate for the imaged image to be displayed to the user and the downscale ratio of the map to be varied in linkage with the zooming function of the like, the user can be saved the trouble of having to manually alter the downscale ratio of the map for instance, resulting in greater convenience for the user.

In other words, map information of an appropriate downscale ratio for the object can be displayed to the user. For instance, when the user is imaging nearby buildings or the like as the object, a map clearly showing buildings and the like around the object can be displayed or, when a distant landscape or the like is being imaged as the object, a map clearly showing far-away mountains in the imaged landscape can be displayed.

Also, the user is enabled to check map information on the surroundings of the object being imaged, to recognize the space around that is not caught by the camera lens or the like and to confirm the route to his or her destination. The user can also anticipate the direction in which the camera is to be faced, think about the scenario of imaging and reduce imaging errors accordingly.

### Second Embodiment

A second embodiment of the present invention will be described below with reference to FIGS. 9 to 10-2. Constituent elements or the like having the same functions as their counterparts in the first embodiment will be assigned respectively the same reference signs, and their description will be dispensed with.

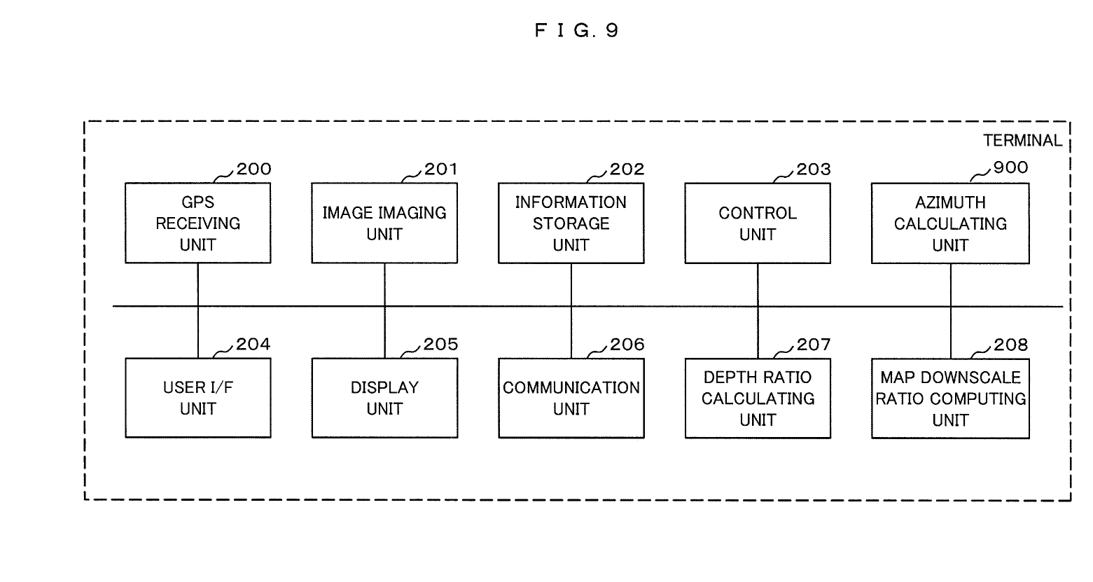

FIG. 9 is a block diagram of a typical configuration of the mobile terminal 104, the tablet terminal 105 and the vehicle-mounted terminal 106 of this embodiment. This is a configuration resulting from addition of an azimuth calculating unit 900.

The azimuth calculating unit 900 may calculate the azimuth of the imaging direction by using geomagnetic sensors capable of detecting feeble geomagnetism or by utilizing the extent of shifting of the GPS positioning result after the lapse of a certain length of time.

For instance, where geomagnetic sensors are used, a plurality of geomagnetic sensors are combined at a right angle to one another to detect geomagnetism in the back-and-forth direction and the right-and-left direction to enable the northward direction to be calculated from the intensities of the geomagnetism and accordingly to measure the azimuth of the imaging direction. In the azimuth calculating unit 900, the azimuth of the imaging direction is figured out from the northward azimuth measured by the geomagnetic sensors and the directions of geomagnetic sensors installed on the terminal.

Where the extent of shifting of the GPS positioning result after the lapse of a certain length of time is to be utilized, the GPS positioning result measured at a certain point of time is stored in advance in the information storage unit 202, GPS positioning is performed again after the lapse of a certain length of time, and the azimuth in which the terminal is shifting is calculated from the difference of the GPS positioning result from the stored GPS positioning result to predict the azimuth in which the terminal is likely to be directed at present.

Since other features of configuration, effects and so forth are the same as those of the first embodiment, their description will be dispensed with.

FIGS. 10-1 and 10-2 show an example of service provided pertaining to this embodiment.

As the configuration shown in FIG. 9 reveals the position of the terminal on the map, the azimuth of image imaging and information on the depth distance of each individual pixel, the map information can be reflected in the imaged image. For instance, such information items as the names of buildings standing in the imaging direction, geographical names in the area and information on their distances can be found out from map information and displayed on the imaged image.

Character information acquired from map information is mapped on the imaged image on the basis of distance information. For matching of depth distance information figured out from the imaged image and distances on the map, one of the conceivable techniques is, as shown in FIG. 6 with regard to the first embodiment, to categorize into six divisions of distance from the imaging position (GPS acquiring position) character information and the like present in map information on the downscale ratio computed by the map downscale ratio computing unit 208 on the basis of information categorized into distance information of six tone equivalents or so calculated by the depth ratio calculating unit 207, and to match information of each divided distance class.

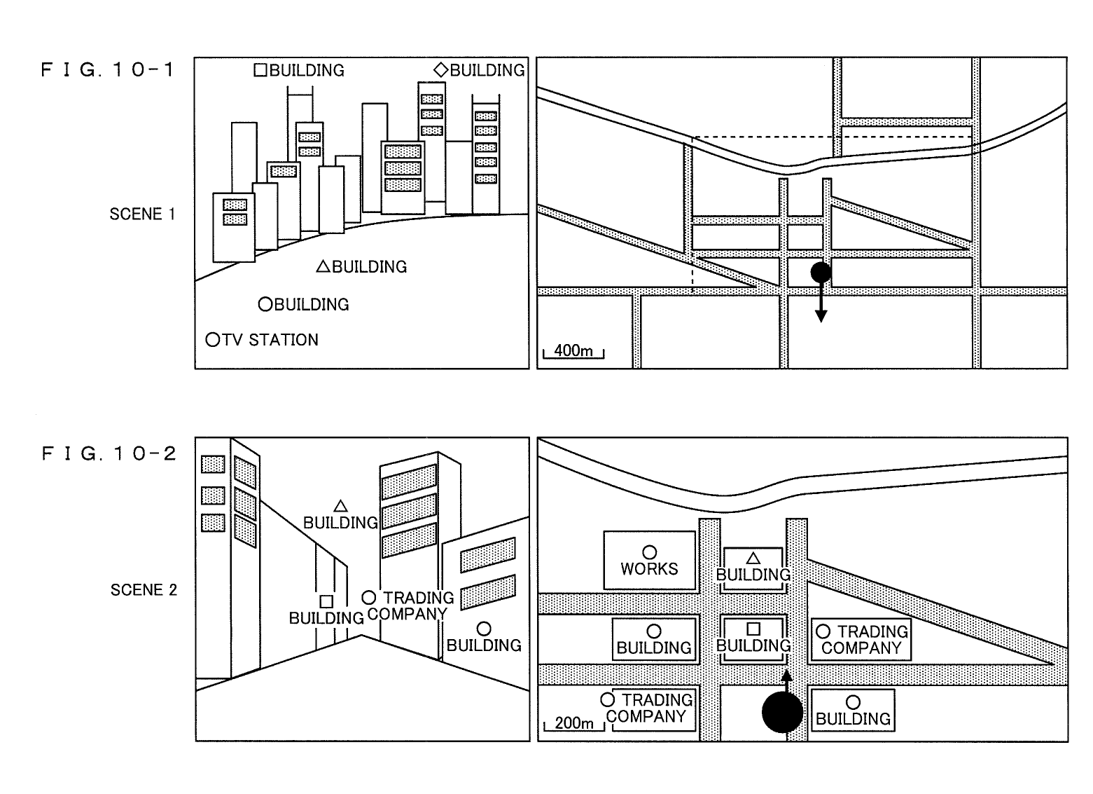

By synthesizing map information, such as character information, with respect to objects present in different azimuths of the imaged image, the service shown in FIG. 10 is made possible. In providing this service, map information on a range matching the imaged scene can be used to utilize map information of the downscale ratio computed by the map downscale ratio computing unit 208.

FIG. 10-1 shows a case where character information on objects shorter in distance from the imaging position in map information is arranged in the lower part of the imaged image while character information on objects longer in distance from the imaging position in map information is arranged in the upper part of the imaged image. This arrangement makes possible easier-to-perceive displaying in a perspective in which the lower part of the imaged image shows nearer objects and the upper part, farther objects.

FIG. 10-2, like FIG. 10-1, shows a case of mapping map information on the imaged image, in which characters indicating nearby objects in map information are displayed in a larger font and far-away objects are in a smaller font. In this way, the perspective of the mapped map information is enabled to give more vivid impressions. Not only the character size but also the relative boldness, font and color of characters may be varied. Further, not only character information contained in map information but also the map information itself may be superposed over the displayed imaged image. In this case, by matching the distance from the current position on the map with depth distance information of the imaged image, a planar map can be projected conceivably.

This embodiment so far described can provide similar advantageous effects to the first embodiment.

Also, as it can display imaged images reflecting character information and the like of map information, the user is enabled to recognize information on the object in the imaged images.

Furthermore, by varying according to distance information the position, size, font, color and other aspects of character information and the like of map information to be reflected in imaged images, the display will enable the user to sense the distance more vividly.

### Third Embodiment

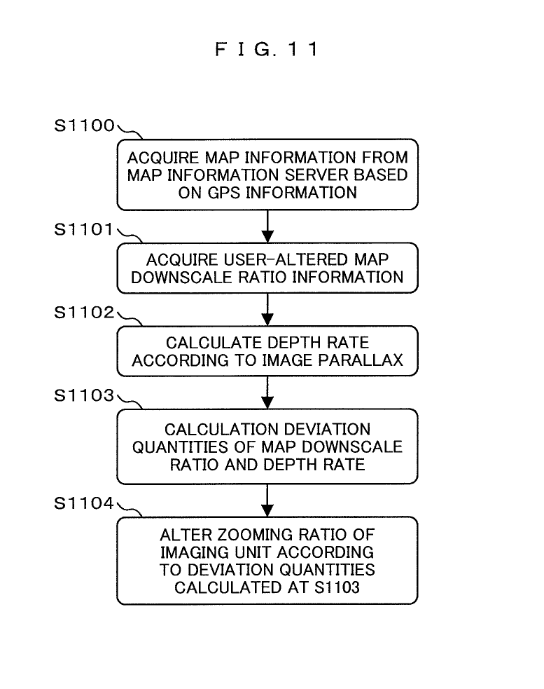

A third embodiment of the present invention will be described below with reference to FIG. 11. Since the configuration of the mobile terminal 104, the tablet terminal 105 and the vehicle-mounted terminal 106 in this embodiment is similar to those of the first and second embodiments illustrated in FIG. 2 and FIG. 9, respectively, its description will be dispensed with.

FIG. 11 is a flow chart showing one example of map information-linked imaging processing in this embodiment.

Here, the map information-linked imaging processing described with reference to FIG. 3 for the first embodiment is a technique by which a change in imaged scene enables map information of a downscale ratio matching that scene to be acquired. FIG. 11 charts a case where the user has changed the downscale ratio of the map via the user I/F unit 204.

For instance, when the user has changed the downscale ratio of the map by utilizing a touch panel or the like, the magnification ratio (zooming rate) of the imaged image is adjusted appropriately to match the downscale ratio of the map by using the zooming function (optical zoom/digital zoom or the like) of the image imaging unit 201.

At S1100, map information is acquired from the map information server 103 on the basis of GPS positional information from the GPS receiving unit 200.

At S1101, if the user has altered the downscale ratio of the map via the user I/F unit 204, the altered map downscale ratio information is acquired.

At S1102, by the same process as at S304 in FIG. 3, the depth rate information on the image being imaged is calculated by analyzing the parallax between the right and left images.

At S1103, by utilizing the list matching the depth rate and the map downscale ratio described with reference to FIG. 7 illustrating the first embodiment, a map downscale ratio appropriate for the imaged image is calculated. Then, the deviation quantity from the map downscale ratio altered by the user at S1101 is calculated.

At S1104, the image imaging unit 201 alters the magnitude according to the deviation quantity calculated at S1103. If a broad range is displayed at a map downscale ratio of 1:5000 and the user manipulates the map to alter it into a detailed map of 1:1000, the imaged image is zoomed in on by using the zooming function of the image imaging unit 201 to increase the share of nearby areas in the depth rate, and the magnitude is so adjusted as to convert the map downscale ratio calculated from the depth rate to 1:1000.

If the image imaging unit 201 is manipulated by the user to perform zooming-in, the downscale ratio of the map varies linked with the zooming as in the first and second embodiments.

This embodiment so far described can provide similar advantageous effects to the first and second embodiments.

When the user desires to check a map of the surroundings, the imaged image can also be zoomed in on linked with the checking action. If the user has displayed a map covering a broader area by raising the downscale ratio, a return to a non-zoomed image is also possible.

### Fourth Embodiment

A fourth embodiment of the present invention will be described with reference to FIGS. 12 to 13-2. Features of configuration and the like similar to those of the first to third embodiments are denoted by respectively the same reference signs, and their description will be dispensed with.

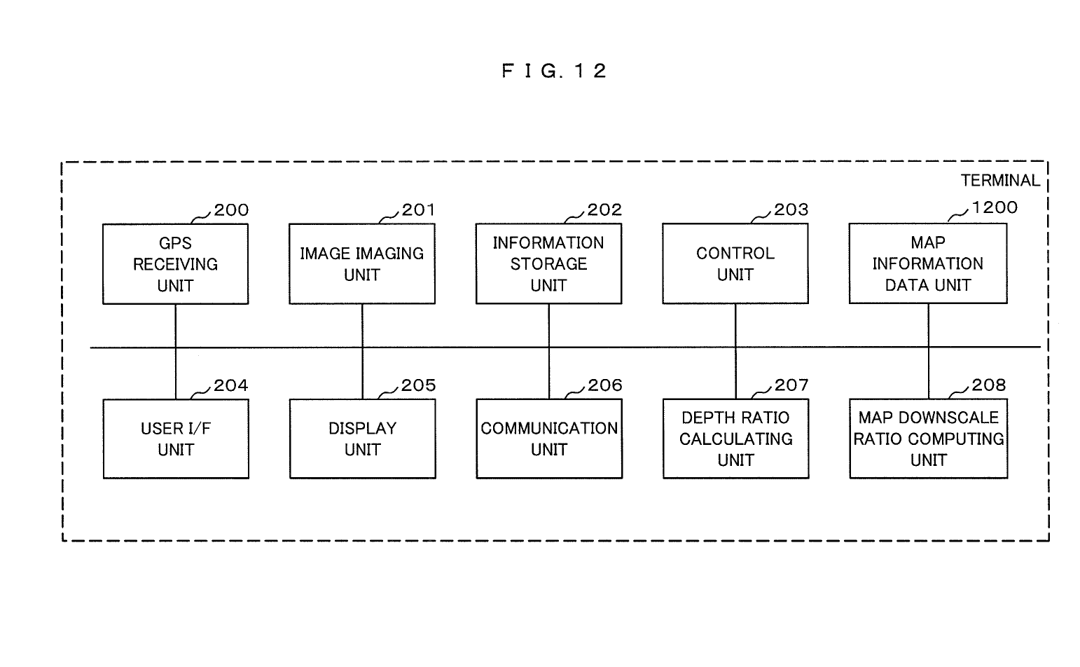

FIG. 12 is a block diagram of a configuration of the mobile terminal 104, the tablet terminal 105 and the vehicle-mounted terminal 106 of this embodiment. This configuration differs from those of the first embodiment and others shown in FIG. 2 and elsewhere in that it has a map information data unit 1200. This embodiment has a configuration for use where map information is present within the terminal, applied to a terminal or a car navigation system having map information built into it. Where the terminal is the mobile terminal 104 or the tablet terminal 105, image information to be displayed on the display unit of an external car navigation apparatus or the like may as well be transmitted via the communication unit 206. Or if the terminal is the vehicle-mounted terminal 106, namely a car navigation apparatus or the like, the communication unit 206 is not always necessary. Various functions of the terminal may also be built into a car (vehicle).

In the configuration shown in FIG. 12, the image imaging unit 201 (camera) is so mounted as to image the area ahead of the vehicle body, and depth ratio information is figured out from imaged images of the image imaging unit 201 to alter the downscale ratio of the map to be displayed on the display unit of the car navigation apparatus or the like. Processing to figure out depth ratio information or to alter the map downscale ratio has already been described with reference to the first to third embodiments.

The map information data unit 1200 holds latest map information, and can search information on the latitude and the longitude for map information on the surroundings. It also has a mechanism to output information as map images at a required downscale ratio, vector map information, character information or the like.

Since other features of configuration, advantageous effects of this embodiment are the same as their respective counterparts in the first to third embodiments, their description will be dispensed with.

FIGS. 13-1 and 13-2 show an example of service pertaining to this embodiment.

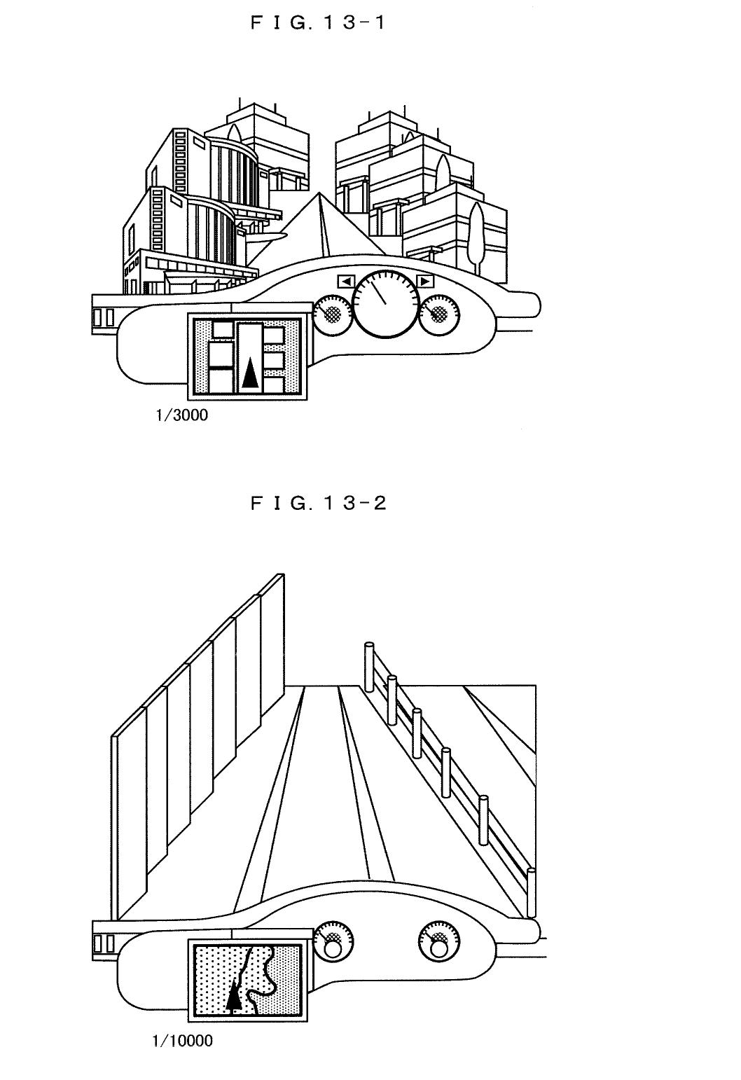

FIG. 13-1 shows a case where a map is displayed on a car navigation system at a downscale ratio calculated from the imaged images of the image imaging unit 201 arranged ahead while the car is traveling in an urban area or the like. As there are buildings and the like nearby and pixels at short distances accounts for a large proportion, the downscale ratio of the map is low, resulting in detailed displaying (at 1:3000 for instance).

On the other hand, as shown in FIG. 13-2, when the vehicle is traveling an expressway or the like, the road width is large, ensuring an unobstructed view ahead, the depth rate information includes a large proportion of long-distance pixels, resulting in a high downscale ratio of the map, which provides broad displaying (at 1:10000 for instance).

This embodiment so far described can provide similar advantageous effects to the first to third embodiments.

Further, as the map downscale ratio automatically varies with the imaged image, the car navigation manipulating load on the driver can be reduced.

While embodiments of the present invention have been described so far, the present invention is not limited to these embodiments, but covers various modifications. For instance, the foregoing embodiments have been described in detail to facilitate understanding of the present invention, but the present invention is not necessarily limited to what has all the constituent elements described above.

For instance, the terminal is not limited to the mobile terminal 104 or the like, but if GPS positional information of any of the embodiments is provided to camera equipment for broadcasting use, it is possible to download onto images of a broadcast landscape map information matched with depth rate information on television equipment from a network connected to the television equipment to enable the audience to watch the broadcast image of the landscape along with map information on the landscape.

The first to third embodiments for instance suppose the existence of the map information server 103 on the network, the terminal itself may possess map information as well. In this case, this art can be applied even to terminals having no communication unit 206, resulting in a broadened range of applicability.

Programs to be operated by the control unit 203 may as well be mounted on the communication unit 206, be recorded on a recording medium to be made available when desired, or be downloaded via a network. By refraining from limiting the modes of distribution to those mentioned here, the present invention can be made available for use in various other ways, resulting in an effect to attract many additional users.

It is also possible to replace part of the configuration of an embodiment with some feature of the configuration of another embodiment and to add some feature of the configuration of an embodiment to that of another. It is further possible to add, delete or replace some constituent features of one embodiment to, with or from another.

Further, the configurations, functions, processors, processing means and the like described above can be either partly or wholly realized with hardware by designing them as integrated circuits. The configurations, functions and so forth described above can be realized with software by causing a processor to interpret and execute programs to implement the respective functions. Information on the programs, tables, files and so forth to realize the functions can be placed in recording devices, such as memories, hard disks, solid state drives (SSDs) or recording media including IC cards, SD cards and DVDs.

Only those control lines and information lines considered necessary for description were mentioned, not necessarily including all the required control lines and information lines. Practically, all the elements of configuration may be deemed to be connected to one another.

### EXPLANATION OF REFERENCES

100: GPS
101: BASE STATION
102: NETWORK
103: MAP INFORMATION SERVER
104: MOBILE TERMINAL
105: TABLET TERMINAL
106: TERMINAL
200: GPS RECEIVING UNIT
201: IMAGE IMAGING UNIT
202: INFORMATION STORAGE UNIT
203: CONTROL UNIT
204: USER INTERFACE UNIT
205: DISPLAY UNIT
206: COMMUNICATION UNIT
207: DEPTH RATIO CALCULATING UNIT
208: MAP DOWNSCALE RATIO COMPUTING UNIT
900: AZIMUTH CALCULATING UNIT
1200: MAP INFORMATION DATA UNIT

1. An information processing device comprising:
an input unit that inputs image information acquired by imaging;
an output unit that outputs map information; and
a control unit that controls the input unit and the output unit,
wherein the control unit performs control, according to depth distance information acquired from the image information, to vary a downscale ratio of the map information outputted from the output unit.

2. The information processing device according to claim 1,
wherein the control unit performs control to vary the downscale ratio of the map information outputted from the output unit according to the rate of pixels or blocks whose values indicated by the depth distance information belong to a prescribed numerical range.

3. The information processing device according to claim 2,
wherein the control by the control unit to vary the downscale ratio of the map information processes downscale ratio switch-over to raise the downscale ratio of the map information in the increasing process of the rate of pixels or blocks whose values indicated by the depth distance information belong to a prescribed numerical range.

4. The information processing device according to claim 2,
wherein the control by the control unit to vary the downscale ratio of the map information processes downscale ratio switch-over to lower the downscale ratio of the map information in the decreasing process of the rate of pixels or blocks whose values indicated by the depth distance information belong to a prescribed numerical range.

5. The information processing device according claim 1, further comprising:
a communication unit that receives the map information; and
a GPS receiver that acquires positional information on the information processing device,
wherein the control unit performs control to receive map information matching the positional information and outputs the map information from the output unit.

6. The information processing device according to claim 1, further comprising:
a recording unit that records the map information; and
a GPS receiver that acquires positional information on the information processing device,
wherein the control unit performs control to read map information matching the positional information out of the recording unit and outputs the map information from the output unit.

7. The information processing device according to claim 1,
wherein the output unit outputs the image information; and
the control unit performs control to measure the azimuth, synthesize information contained in the map information into the image information and output the image information.

8. The information processing device according to claim 1, further comprising:
a user input unit that inputs user inputs,
wherein the control unit performs control to alter, when the downscale ratio of the map information has been varied by the user input, the imaging magnitude of image imaging.

9. An information processing method for use in an information processing device comprising:
inputting image information acquired by image imaging into the input unit; and
outputting map information from the output unit,
wherein, when outputting, the downscale ratio of the map information outputted from the output unit is varied according to depth distance information acquired from the image information.

10. The information processing method according to claim 9,
wherein, when outputting, the downscale ratio of the map information outputted from the output unit is varied according to the rate of pixels or blocks whose values indicated by the depth distance information belong to a prescribed numerical range.

11. The information processing method according to claim 10,
wherein, when outputting, the downscale ratio of the map information processes downscale ratio switch-over to raise the downscale ratio of the map information in the increasing process of the rate of pixels or blocks whose values indicated by the depth distance information belong to a prescribed numerical range.

12. The information processing method according to claim 10,
wherein, when outputting, the downscale ratio of the map information processes downscale ratio switch-over to lower the downscale ratio of the map information in the decreasing process of the rate of pixels or blocks whose values indicated by the depth distance information belong to a prescribed numerical range.

13. A program to cause an information processing device to execute processing including:
inputting image information acquired by image imaging into an input unit; and
outputting map information from an output unit,
wherein, when outputting, the downscale ratio of the map information outputted from the output unit is varied according to depth distance information acquired from the image information.

14. The program according to claim 13,
wherein, when outputting, the downscale ratio of the map information outputted from the output unit is varied according to the rate of pixels or blocks whose values indicated by the depth distance information belong to a prescribed numerical range.
